(19) United States
(12) Patent Application Publication
(10) Pub. No.: US 2023/0041814 A1
(43) Pub. Date: Feb. 9, 2023

(54) SYSTEM AND METHOD FOR DEMONSTRATING OBJECTS AT REMOTE LOCATIONS

(71) Applicant: Lenovo (Singapore) Pte. Ltd., New Tech Park (SG)

(72) Inventors: John W. Nicholson, Cary, NC (US); Howard Locker, Cary, NC (US); Daryl C. Cromer, Raleigh, NC (US); Mengnan Wang, Chapel Hill, NC (US)

(21) Appl. No.: 17/395,502

(22) Filed: Aug. 6, 2021

(51) Int. Cl. G06T 17/00; G06F 3/14; G01B 11/22; G01S 17/10

(52) U.S. Cl. CPC G06T 17/00; G06F 3/1454; G01B 11/22; G01S 17/10

(57) ABSTRACT

A system and method include a depth sensing device configured to sense an object within a sensing space at an object sensing location. The depth sensing device is configured to output one or more depth signals regarding the object. A control unit is in communication with the depth sensing device. The control unit is configured to receive the one or more depth signals and construct a model of the object from the one or more depth signals. The control unit is further configured to output a model signal regarding the model of the object to one or more object reproduction devices at one or more monitoring locations that differ from the object sensing location. The model of the object is shown by the one or more object reproduction devices.

### BACKGROUND

Embodiments herein generally relate to systems and methods for demonstrating (for example, showing and viewing) objects, such as prototypes, at various locations.

Video conferencing allows individuals at different locations to virtually meet. During video conferencing, sharing a physical object such as a prototype with remote meeting participants is not always possible. For example, prototypes may not be physically sent to each location. As such, during a virtual meeting, an individual may share photographic or video images of the object with the remote participants.

However, an individual typically uses at least one hand to manipulate a photographic or video camera to image the object. As can be appreciated, at least one hand of the individual is unable to be used to manipulate the actual object as the individual operates the camera to image the object. Further, there may be difficulty in trying to manipulate the object and the camera while ensuring that the object remains in the field of view of the camera.

As another option, a computer-aided design (CAD) model can be shared during the virtual meeting. However, with certain objects, such as prototypes, the CAD model may not accurately exhibit all of the specific properties of an actual prototype. Moreover, individuals who are not fully experienced with CAD may not always be able to operate CAD software to demonstrate the object therethrough, particularly if the object includes moving parts.

### SUMMARY

A need exists for a system and a method for effectively and efficiently demonstrating an object during a virtual meeting. Further, a need exists for a system and a method that allows a presenter of an object to use both hands to manipulate the object during the virtual meeting.

With those needs in mind, certain embodiments of the present disclosure provide a system including a depth sensing device configured to sense an object within a sensing space at an object sensing location. The depth sensing device is configured to output one or more depth signals regarding the object. A control unit is in communication with the depth sensing device. The control unit is configured to receive the one or more depth signals and construct a model of the object from the one or more depth signals. The control unit is further configured to output a model signal regarding the model of the object to one or more object reproduction devices at one or more monitoring locations that differ from the object sensing location. The model of the object is shown by the one or more object reproduction devices.

In at least one embodiment, the depth sensing device includes one or more sensors configured to detect points in the sensing space. In at least one embodiment, the depth sensing device is not a photographic camera or a video camera. As an example, the depth sensing device is a light detection and ranging (LIDAR) device. As another example, the depth sensing device is a projected pattern camera.

In at least one embodiment, the control unit is at the object sensing location. In at least one other embodiment, the control unit is remote from the object sensing location.

In at least one embodiment, the model signal includes an entirety of the model. In at least one other embodiment, the model signal includes less than an entirety of the model.

The depth sensing device is configured and supported to be able to sense an entire object. In at least one example, the depth sensing device is supported over a floor by a base. In at least one other example, the depth sensing device is mounted to a wall of the object sensing location. In at least one other example, the depth sensing device is mounted to a ceiling of the object sensing location.

In at least one embodiment, the control unit is further configured to ignore extraneous components that differ from the object.

Certain embodiments of the present disclosure provide a method including sensing, by a depth sensing device, an object within a sensing space at an object sensing location; outputting, by the depth sensing device, one or more depth signals regarding the object; receiving, by a control unit in communication with the depth sensing device, the one or more depth signals; constructing, by the control unit, a model of the object from the one or more depth signals; outputting, by the control unit, a model signal regarding the model of the object to one or more object reproduction devices at one or more monitoring locations that differ from the object sensing location; and showing, by the one or more object reproduction devices, the model of the object.

### BRIEF DESCRIPTION OF THE DRAWINGS

FIG. 1 illustrates a schematic block diagram of a system for demonstrating an object at a plurality of locations, according to an embodiment of the present disclosure.

FIG. 2 illustrates a schematic block diagram of a depth sensing device at an object sensing location, according to an embodiment of the present disclosure.

FIG. 3 illustrates a schematic block diagram of a depth sensing device at an object sensing location, according to an embodiment of the present disclosure.

FIG. 4 illustrates a schematic block diagram of a depth sensing device at an object sensing location, according to an embodiment of the present disclosure.

FIG. 5 illustrates a simplified view of an object.

FIG. 6 illustrates a flow chart of a method for demonstrating an object at a plurality of locations, according to an embodiment of the present disclosure.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Embodiments of the present disclosure provide systems and methods for demonstrating an object at a plurality of locations, such as during a video or virtual conference. The systems and methods include a depth sensing device that is configured to image the object. A control unit is in communication with the depth sensing device. The control unit is further in communication with one or more object reproduction devices at one or more locations that are remote from the location where the object resides.

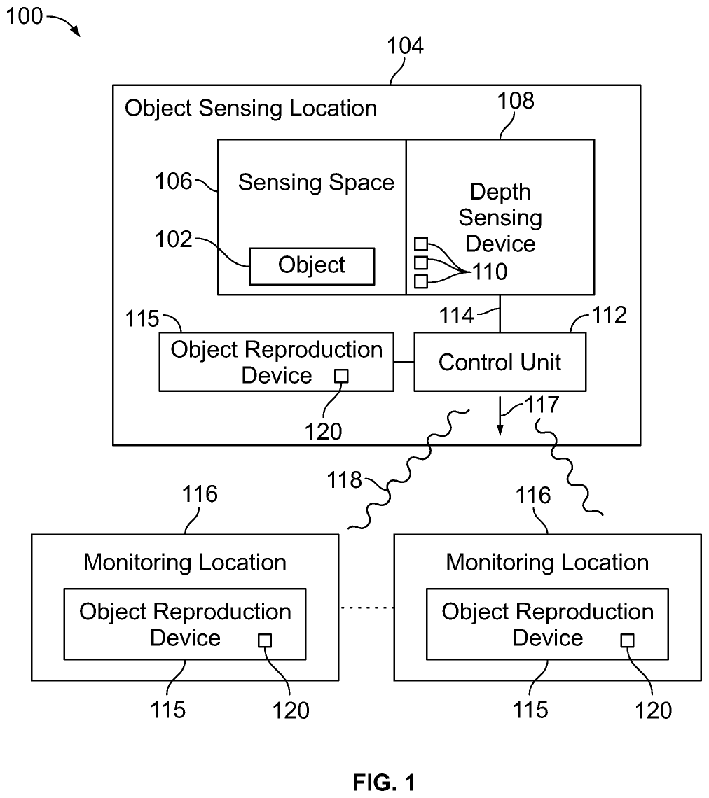

FIG. 1 illustrates a schematic block diagram of a system 100 for demonstrating an object 102 at a plurality of locations, according to an embodiment of the present disclosure. In at least one embodiment, the object 102 is a prototype. Optionally, the object 102 can be any type of structure that is to be demonstrated (for example, shown and viewed).

The object 102 is at a first location, such as an object sensing location 104. The object 102 is within a sensing space 106 of a depth sensing device 108. The depth sensing device 108 includes one or more sensors 110 that are configured to detect points in space, such as the sensing space 106. The sensing space 106 is within a field of view of the one or more sensors 110. The sensor(s) 110 output signals that include depth information. In at least one embodiment, the depth sensing device 108 is not a photographic or video camera. For example, in at least one embodiment, the sensor(s) 110 do not output photographic or video data.

In at least one embodiment, the depth sensing device 108 is a light detection and ranging (LIDAR) device, such as a LIDAR scanner. As an example, the LIDAR device includes one or more sensors, such as the sensors 110, that emit pulsed lasers to calculate a depth distances of the object 102 within the sensing space 106. LIDAR is a type of time-of-flight device that sends waves of pulsed light, such as in a spray of infrared dots, and can measure the pulsed light with the sensors 110, thereby creating a field of points that map distances and can mesh the dimensions of a space and the object 102 therein. As an example, the sensing space 106 (or field of view) for the LIDAR device can be 20 feet or less. In at least one other embodiment, the sensing space 106 can be greater than 20 feet, such as 50 feet, 100 feet, or the like. Optionally, the depth sensing device 108 can be other types of time-of-flight devices. As another example, the depth sensing device 108 can be a projected pattern camera, which outputs a pattern, such as a dot pattern. As another example, the depth sensing device 108 can be an infrared camera.

The depth sensing device 108 is in communication with a control unit 112, such as through one or more wired or wireless connections. The control unit 112 is configured to receive signals 114 indicative of the object 102. The signals 114 (for example, depth signals) include the depth information from the depth sensing device 108. In at least one embodiment, the signals 114 do not include photographic or video data. The control unit 112 analyzes the signals 114 and constructs an electronic, virtual three dimensional (3D) model (such as transmitted via a model signal 117) of the object 102. As another example, the signals 114 can be sent to the object reproduction device 115, which can construct the 3D model (such as via a control unit). An object reproduction device 115 shows the model 120. The object reproduction device 115 is in communication with the control unit 112, such as through one or more wired or wireless connections. For example, the object reproduction device 115 can receive data from the control unit 112 via an intranet, internet, or the like.

The control unit 112 constructs the 3D model of the object, via the signals 114 received from the depth sensing device 108, and displays the 3D model 120 on the object reproduction device 115, which can be an electronic monitor, such as a computer or television screen, which can be two-dimensional (2D) or 3D. As another example, the object reproduction device 115 can be a 3D monitoring sub-system, such as a holographic sub-system or the like. As another example, the object reproduction device 115 can be an augmented reality or virtual reality sub-system.

Optionally, the object sensing location 104 may not include the object reproduction device 115. Further, the control unit 112 may or may not be at the object sensing location 104. For example, control unit 112 can be remote from the object sensing location, such as at a different location, and may be in communication with the depth sensing device 108, such as through a wireless connection, network, and/or the like.

The control unit 112 is in communication with an object reproduction device 115 (such as an electronic monitor, screen, 3D viewing sub-system, augmented reality sub-system, virtual reality sub-system, and/or the like) at one or more other locations (such as second, third, fourth, and the like), such as one or more monitoring locations 116. The monitoring locations 116 are remote (that is, not co-located) from the object sensing location 104. The control unit 112 is in communication with the object reproduction devices 115, such as through a network 118, another wireless connection, and/or optionally a wired connection. In at least one embodiment, the control unit 112 is in communication with the object reproduction devices 115 at the monitoring locations 116 through a wireless communications channel and/or through a network connection (for example, the Internet). The network 118 may represent one or more of a local area network (LAN), a wide area network (WAN), an Intranet or other private network that may not be accessible by the general public, or a global network, such as the Internet or other publicly accessible network.

The system 100 can include any number of monitoring locations 116. For example, the system 100 can include the object sensing location 104 and one monitoring location 116. As another example, the system 100 can include two mor more monitoring locations 116. As a further example, the system 100 can include three, four, five, six, or more monitoring locations 116. The monitoring locations 116 may or may not also include depth sensing devices.

In operation, the depth sensing device 108 senses the object 102, and outputs the signals 114 indicative of depth ranges of various surfaces, features, and the like of the object 102 to the control unit 112. In at least one embodiment, the depth sensing device 108 is configured to sense the object 102 without an individual manipulating or otherwise handling the depth sensing device 108, thereby allowing the individual to manipulate and handle the object 102, such as with both hands, as the object 102 is being sensed by the depth sensing device 108, and the control unit 112 constructs the 3D model and outputs the 3D model (or a portion thereof), including different poses of the object as an individual may move the object, to the object reproduction devices 115 (which shown the model 120) at the one or more monitoring locations 116. The control unit 112 constantly maps and updates the 3D model, and transmits the 3D model to the object reproduction devices 115 of the monitoring locations 116.

In at least one embodiment, the control unit 112 renders the 3D model through field of points mapping. In at least one embodiment, the control unit 112 renders the 3D model of the object 102 in real time. Manipulations of the object 102 within the sensing space 106 are thereby shown on the objection reproduction devices 115 at the monitoring locations 116.

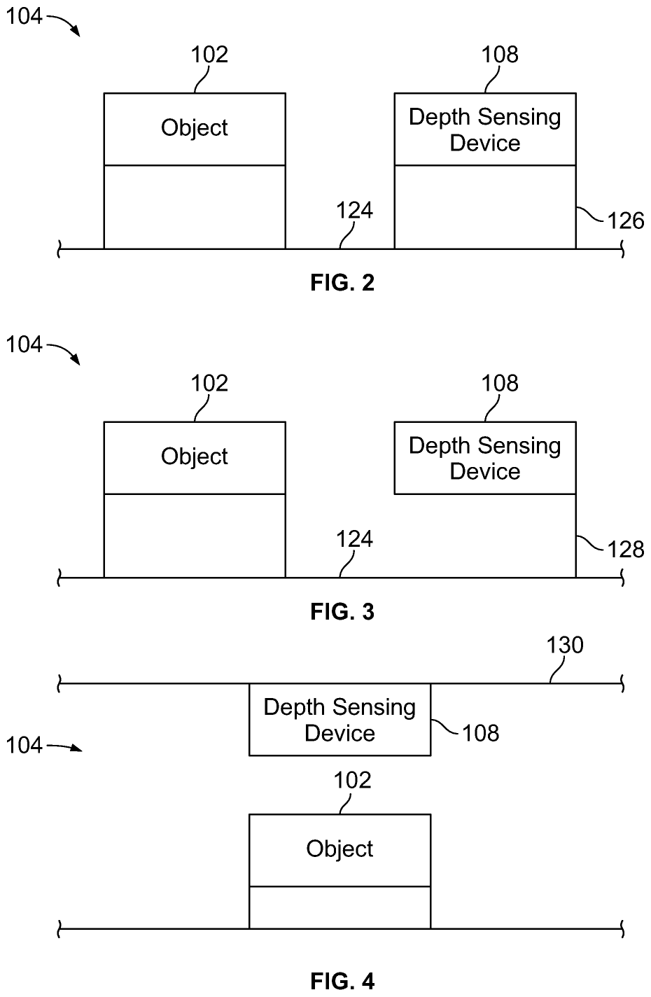

FIG. 2 illustrates a schematic block diagram of the depth sensing device 108 at an object sensing location 104, according to an embodiment of the present disclosure. As shown, the depth sensing device 108 can be supported over a floor 124 by a base 126, such as one or more legs, a table, a step, a tripod, one or more columns, and/or the like. In at least one embodiment, the base 126 is integrally formed with the depth sensing device 108. Optionally, the base 126 can be separate and distinct from the depth sensing device 108 (for example, the depth sensing device 108 can be separately placed on the base 126).

FIG. 3 illustrates a schematic block diagram of a depth sensing device 108 at an object sensing location 104, according to an embodiment of the present disclosure. As shown, the depth sensing device 108 can be mounted to a wall 128 (either directly through one or more fasteners, adhesives, or the like, or indirectly, such as through an intermediate bracket, beam, arm, and/or the like) of the object sensing location 104.

FIG. 4 illustrates a schematic block diagram of a depth sensing device 108 at an object sensing location 104, according to an embodiment of the present disclosure. As shown, the depth sensing device 108 can be mounted to a ceiling 130 (either directly through one or more fasteners, adhesives, or the like, or indirectly, such as through an intermediate bracket, beam, arm, and/or the like) of the object sensing location 104.

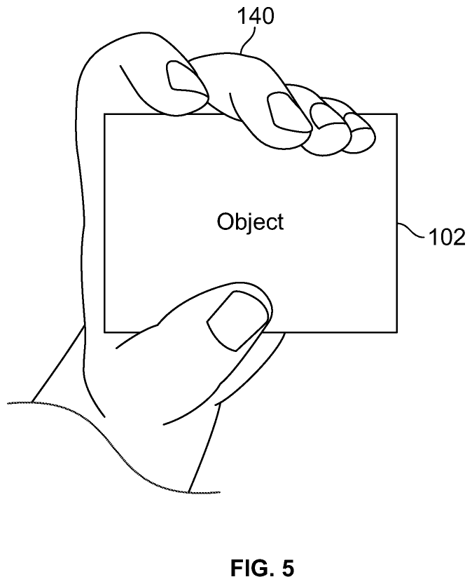

FIG. 5 illustrates a simplified view of the object 102. Referring to FIGS. 1 and 5, the object 102 can first be fully scanned by the depth sensing device 108 before being handled by an individual. For example, during an object calibration, every surface of the object 102 can first be scanned by the depth sensing device 108 without an intervening structure, components, or the like on or around the object 102. In this manner, the control unit 112 can then construct the 3D model of the object 102 without extraneous components. As such, when an individual handles the object 102, the control unit 112 is able to fully construct the model no matter the orientation of a particular pose (such as via registration of a plurality of points of the object 102). Further, the control unit 112 can then ignore sensed depth data from the depth sensing device 108 from other extraneous components, such as a hand 140. In this manner, the control unit 112 can focus computing power on the object 102 itself, disregard the extraneous components, and therefore efficiently utilize computing power.

In at least one embodiment, the control unit 112 constrains data regarding the 3D model of the object 102 (for example, point cloud data) to the object 102 itself, which allows for removal of extraneous components, such as hands holding the object 102. As another option, other objects of interest, such as pointing devices, fingers, or the like, can be selectively included in the 3D model to be shown on the object reproduction devices 115. For example, an individual can select additional components (such as pointing devices, fingers, or the like) for the control unit 112 to show, such as via a user interface that is in communication with the control unit 112.

In at least one embodiment, the control unit 112 combines the 3D model of the object 102 with field of points mapping, which may include registration of points, to reduce bandwidth and computing power, as well as fill in gaps of the object 102, which may be covered or otherwise hidden (such as by portions of the hand 140). In at least one embodiment, the control unit 112 can output the model signal 117, which may include only certain points of the 3D model, to indicate how the object 102 is being manipulated within the sensing space 106. The full 3D model of the object 102 can be already at the monitoring locations 116. The control unit 112 may output the model signal 117, which may include only portions of the 3D model, such as three points of the 3D model, in order to reduce bandwidth and computing power. The monitoring locations 116, which already have the 3D model, can update based on the point data output by the control unit 112. Optionally, the model signal 117 can include all data regarding the 3D model of the object 102.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 112 may be or include one or more processors that are configured to control operation, as described herein.

The control unit 112 is configured to execute a set of instructions that are stored in one or more data storage units or elements (such as one or more memories), in order to process data. For example, the control unit 112 may include or be coupled to one or more memories. The data storage units may also store data or other information as desired or needed. The data storage units may be in the form of an information source or a physical memory element within a processing machine.

The set of instructions may include various commands that instruct the control unit 112 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the control unit 112. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 112 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-5, in at least one embodiment, the system 100 includes the depth sensing device 108, which is configured to sense the object 102 within the sensing space 106 at the object sensing location 104. The depth sensing device 108 is configured to output one or more depth signals 114 regarding the object 102 (for example, the depth signal(s) 114 includes data regarding the sensed attributes of the object 102). The control unit 112 is in communication with the depth sensing device 108, and is configured to receive the one or more signals 114 and construct a model of the object 102. The control unit 112 is further configured to output a model signal 117 regarding the model of the object 102 to one or more object reproduction devices 115 at one or more monitoring locations 116 that differ (that is, not co-located) from the object sensing location 104. The model 120 of the object 102 is shown by the one or more object reproduction devices 115.

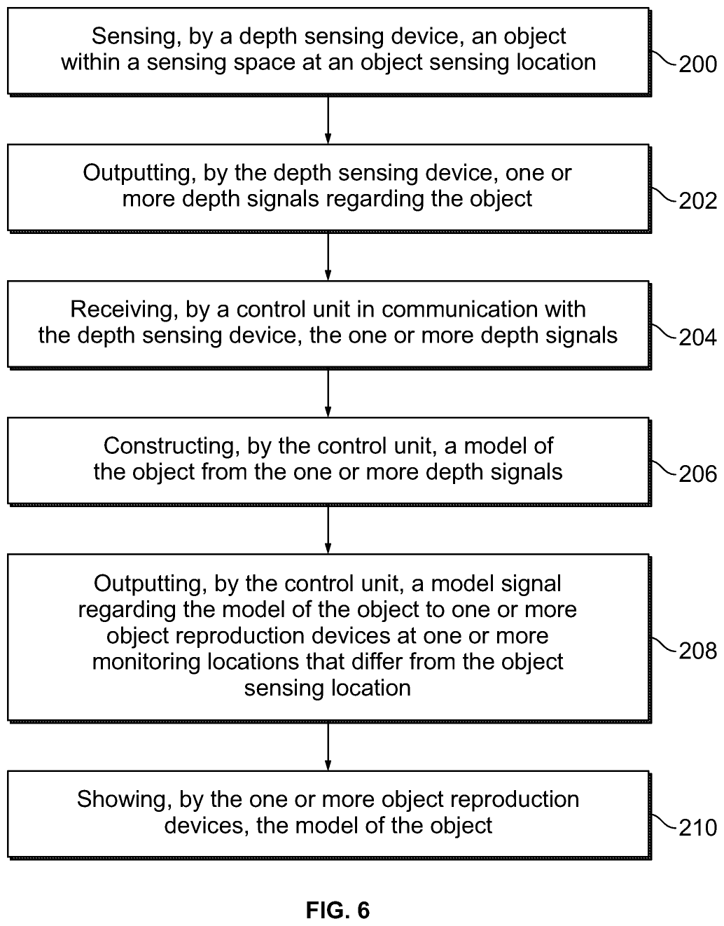

FIG. 6 illustrates a flow chart of a method for demonstrating an object at a plurality of locations, according to an embodiment of the present disclosure. Referring to FIGS. 1 and 6, the method includes sensing 200, by the depth sensing device 108, the object 102 within the sensing space 106 at the object sensing location 104; outputting 202, by the depth sensing device 108, one or more depth signals 114 regarding the object 102; receiving 204, by the control unit 112 in communication with the depth sensing device 108, the one or more depth signals 114; constructing 206, by the control unit 112, a model of the object 102 from the one or more depth signals 114; outputting 208, by the control unit 112, a model signal 117 regarding the model 120 of the object to one or more object reproduction devices 115 at one or more monitoring locations 116 that differ from the object sensing location 104; and showing 210, by the one or more object reproduction devices 115, the model 120 of the object 102.

In at least one embodiment, said sensing 200 includes detecting, by one or more sensors 110 of the depth sensing device 108, points (such as of the object 102) in the sensing space 106.

In at least one embodiment, the model signal 117 includes an entirety of the model. In at least one other embodiment, the model signal 117 includes less than an entirety of the model.

In at least one embodiment, the method also includes ignoring, by the control unit 112, extraneous components (such as portions of a hand) that differ from the object 102.

Further, the disclosure comprises embodiments according to the following clauses:

Clause 1: A system comprising:

a depth sensing device configured to sense an object within a sensing space at an object sensing location, wherein the depth sensing device is configured to output one or more depth signals regarding the object; and

a control unit in communication with the depth sensing device, wherein the control unit is configured to receive the one or more depth signals and construct a model of the object from the one or more depth signals, wherein the control unit is further configured to output a model signal regarding the model of the object to one or more object reproduction devices at one or more monitoring locations that differ from the object sensing location, and wherein the model of the object is shown by the one or more object reproduction devices.

Clause 2. The system of Clause 1, wherein the depth sensing device includes one or more sensors configured to detect points in the sensing space.

Clause 3. The system of Clauses 1 or 2, wherein the depth sensing device is not a photographic camera or a video camera.

Clause 4. The system of any of Clauses 1-3, wherein the depth sensing device is a light detection and ranging (LIDAR) device.

Clause 5. The system of any of Clauses 1-3, wherein the depth sensing device is a projected pattern camera or an infrared camera.

Clause 6. The system of any of Clauses 1-5, wherein the control unit is at the object sensing location.

Clause 7. The system of any of Clauses 1-5, wherein the control unit is remote from the object sensing location.

Clause 8. The system of any of Clauses 1-7, wherein the model signal includes an entirety of the model.

Clause 9. The system of any of Clauses 1-8, wherein the model signal includes less than an entirety of the model.

Clause 10. The system of any of Clauses 1-9, wherein the depth sensing device is supported over a floor by a base.

Clause 11. The system of any of Clauses 1-9, wherein the depth sensing device is mounted to a wall of the object sensing location.

Clause 12. The system of any of Clauses 1-9, wherein the depth sensing device is mounted to a ceiling of the object sensing location.

Clause 13. The system of any of Clauses 1-12, wherein the control unit is further configured to ignore extraneous components that differ from the object.

Clause 14. A method comprising:

sensing, by a depth sensing device, an object within a sensing space at an object sensing location;

outputting, by the depth sensing device, one or more depth signals regarding the object;

receiving, by a control unit in communication with the depth sensing device, the one or more depth signals;

constructing, by the control unit, a model of the object from the one or more depth signals;

outputting, by the control unit, a model signal regarding the model of the object to one or more object reproduction devices at one or more monitoring locations that differ from the object sensing location; and showing, by the one or more object reproduction devices, the model of the object.

Clause 15. The method of Clause 14, wherein said sensing comprises detecting, by one or more sensors of the depth sensing device, points in the sensing space.

Clause 16. The method of Clauses 14 or 15, wherein the depth sensing device is a light detection and ranging (LIDAR) device.

Clause 17. The method of any of Clauses 14-16, wherein the model signal includes an entirety of the model.

Clause 18. The method of any of Clauses 14-16, wherein the model signal includes less than an entirety of the model.

Clause 19. The method of any of Clauses 14-18, further comprising ignoring, by the control unit, extraneous components that differ from the object.

Clause 20. A system comprising:

a depth sensing device configured to sense an object within a sensing space at an object sensing location, wherein the depth sensing device includes one or more sensors configured to detect points in the sensing space, and wherein the depth sensing device is configured to output one or more depth signals regarding the object;

a control unit in communication with the depth sensing device, wherein the control unit is configured to receive the one or more depth signals and construct a model of the object from the one or more depth signals, wherein the control unit is further configured to output a model signal regarding the model of the object;

one or more object reproduction devices at one or more monitoring locations that differ from the object sensing location, wherein the one or more object reproduction devices are configured to receive the model signal from the control unit, and one or more reproduction devices are configured to show the model of the object.

As described herein, embodiments of the present disclosure provide systems and methods for effectively and efficiently demonstrating an object during a virtual meeting. Further, embodiments of the present disclosure provide systems and methods that allow a presenter of an object to use both hands to manipulate the object during the virtual meeting.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a depth sensing device configured to sense an object within a sensing space at an object sensing location, wherein the depth sensing device is configured to output one or more depth signals regarding the object; and
a control unit in communication with the depth sensing device, wherein the control unit is configured to receive the one or more depth signals and construct a model of the object from the one or more depth signals, wherein the control unit is further configured to output a model signal regarding the model of the object to one or more object reproduction devices at one or more monitoring locations that differ from the object sensing location, and wherein the model of the object is shown by the one or more object reproduction devices.

2. The system of claim 1, wherein the depth sensing device includes one or more sensors configured to detect points in the sensing space.

3. The system of claim 1, wherein the depth sensing device is not a photographic camera or a video camera.

4. The system of claim 1, wherein the depth sensing device is a light detection and ranging (LIDAR) device.

5. The system of claim 1, wherein the depth sensing device is a projected pattern camera or an infrared camera.

6. The system of claim 1, wherein the control unit is at the object sensing location.

7. The system of claim 1, wherein the control unit is remote from the object sensing location.

8. The system of claim 1, wherein the model signal includes an entirety of the model.

9. The system of claim 1, wherein the model signal includes less than an entirety of the model.

10. The system of claim 1, wherein the depth sensing device is supported over a floor by a base.

11. The system of claim 1, wherein the depth sensing device is mounted to a wall of the object sensing location.

12. The system of claim 1, wherein the depth sensing device is mounted to a ceiling of the object sensing location.

13. The system of claim 1, wherein the control unit is further configured to ignore extraneous components that differ from the object.

14. A method comprising:
sensing, by a depth sensing device, an object within a sensing space at an object sensing location;
outputting, by the depth sensing device, one or more depth signals regarding the object;
receiving, by a control unit in communication with the depth sensing device, the one or more depth signals;
constructing, by the control unit, a model of the object from the one or more depth signals;
outputting, by the control unit, a model signal regarding the model of the object to one or more object reproduction devices at one or more monitoring locations that differ from the object sensing location; and
showing, by the one or more object reproduction devices, the model of the object.

15. The method of claim 14, wherein said sensing comprises detecting, by one or more sensors of the depth sensing device, points in the sensing space.

16. The method of claim 14, wherein the depth sensing device is a light detection and ranging (LIDAR) device.

17. The method of claim 14, wherein the model signal includes an entirety of the model.

18. The method of claim 14, wherein the model signal includes less than an entirety of the model.

19. The method of claim 14, further comprising ignoring, by the control unit, extraneous components that differ from the object.

20. A system comprising:
a depth sensing device configured to sense an object within a sensing space at an object sensing location, wherein the depth sensing device includes one or more sensors configured to detect points in the sensing space, and wherein the depth sensing device is configured to output one or more depth signals regarding the object;
a control unit in communication with the depth sensing device, wherein the control unit is configured to receive the one or more depth signals and construct a model of the object from the one or more depth signals, wherein the control unit is further configured to output a model signal regarding the model of the object; and
one or more object reproduction devices at one or more monitoring locations that differ from the object sensing location, wherein the one or more object reproduction devices are configured to receive the model signal from the control unit, and one or more reproduction devices are configured to show the model of the object.
